(19) United States
(12) Patent Application Publication
(10) Pub. No.: US 2009/0094150 A1
(43) Pub. Date: Apr. 9, 2009

(54) Method and client system for implementing online secure payment

(75) Inventors: Rongfeng Feng, Beijing (CN); Chunmei Liu, Beijing (CN); Yi Zhang, Beijing (CN); Min Hu, Beijing (CN)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: LENOVO (BEIJING) LIMITED, Beijing (CN)

(21) Appl. No.: 12/287,191

(22) Filed: Oct. 7, 2008

(30) Foreign Application Priority Data
Oct. 8, 2007 (CN) 200710175608.8

(51) Int. Cl. G06Q 40/00

(52) U.S. Cl. 705/35

(57) ABSTRACT

The invention discloses a method for implementing an online secure payment, which comprises steps of: transmitting to a dedicated operating system a secure payment request page for goods which is generated in a general operating system; and completing a payment operation in the secure payment request page of the dedicated operating system, after switching from the general operating system to the dedicated operating system. The invention further comprises a client system for implementing an online secure payment. In the invention, the general operating system for general operations is distinguished from the dedicated operating system for secure payment operations, and the security for the network payment is further enhanced by configuring the firewall and monitoring processes in the dedicated operating system. Furthermore, it is not necessary to make any modification on the existed network transaction system when the technical solution of the present invention is applied, the cost may be reduced and the technical solution of the present invention is facilitated to be deployed and spread.

### BACKGROUND OF THE INVENTION

1. Field of Invention

The present invention relates to a field of computer technique, particularly to a method and a client system for implement an online secure payment.

2. Description of Prior Art

With an increasing popularization of a shopping approach over a network, a network payment becomes a main payment manner. A high security and a high privacy are required for the network payment. For this end, various efforts are paid by banks and merchants supporting the network shopping for improving securities of the network and client systems. However, since the client system has always lacked a secure and trustable computing environment for a long time, some hackers and malicious software may attack a process in the network payment through the client system. FIG. 1 illustrates a typical payment flowchart for a network shopping in a prior art. A whole transaction process in the network payment concerns three parties of a client system, a network bank and a merchant, and the process in detail is as follows:

In step 101, a user browses goods of the merchant on a webpage through the client system, and orders goods he needs.

In step 102, the merchant returns to the user a goods payment order which is generated based on the user's order.

In step 103, the user pays amount of money on the payment order for the selected goods through the network bank on the client system

In step 104, the network bank notifies the merchant that the payment for the goods has been completed when the network bank receives the amount of money for the goods paid by the user.

In step 105, the merchant delivers the goods to the user when he confirms the completion of the payment.

In the above payment process, the step 103 has a requirement for high privacy and high security. Other steps have relative a low requirement for security with respect to the step 103, and only have a higher requirement for interaction and personalization. To improve the security of information transaction between the client system and the network bank in the step 103, a protected mode for IE7 may be used on the client system. The protected mode may be entered based on the requirement of the client system user, or entered automatically. In the protected mode, IE has a relative low execution right, thus the user of the client system may only access preset trustable sites. The trustable sites may exist in a list on the client system. The user may add a URL (Uniform Resource Locations) of a trustable site considered by himself to the list of trustable sites. The trustable sites are generally payment gateways of the network bank. When the client system user accesses some website in which Trojan horse exists, the Trojan horse can not control an operating system of the whole client system through the IE process, since this website does not be listed in the list of trusted sites accessed by the user due to a relative low IE right of the website.

As known from the above description about the prior art, when a transaction between the client system and the network bank is security-protected by means of the IE7 protected mode, the malicious software may be prevented from intruding the operating system of the client system through the IE only by setting the list of trustable sites. However, other approaches for intruding the operating system of the client system by the malicious software can not be prevented. For example, it is not possible to avoid the malicious software on the host operating system to detect input and output information of the user through a bottom layer. For Trojan horse which has intruded in, the client system can not prevent the attack of the Trojan horse on the operating system and the capture of the input and output information of the user.

### SUMMARY OF THE INVENTION

Accordingly, an object of the present invention is to provide a method for implementing an online secure payment, in order to solve a problem that malicious software on an operating system can not be avoided by the method in the prior art to detect input and output information of a user.

Another object of the present invention is to provide a client system for implementing an online secure payment, in order to solve a problem in a prior art that malicious software on an operating system can not be avoided by the client system in the prior art to detect input and output information of a user.

For solving the above technical problems, technical solutions are provided by the present invention as follows:

A method for implementing an online secure payment comprises steps of:

transmitting to a dedicated operating system a secure payment request page for goods which is generated in a general operating system; and
completing a payment operation in the secure payment request page of the dedicated operating system, after switching from the general operating system to the dedicated operating system.

The method further comprises steps of:

triggering an access request for a payment gateway of the goods after the goods have been selected in the general operating system; and
determining whether the payment gateway exists in a list of payment gateways pre-stored in the general operating system; if so, preventing the payment gateway from being accessed in the general operating system, and generating the secure payment request page; otherwise, the process being ended.

The step of generating the secure payment request page in the general operating system comprises steps of:

extracting payment request information in an initial payment request page generated in the general operating system; and
encapsulating the payment request information into the secure payment request page which is a file containing information on a Hypertext Transfer Protocol (HTTP) request for the payment gateway.

The step of transmitting to the dedicated operating system the secure payment request page comprises steps of:

driving an information channel between the general operating system and the dedicated operating system; and
transmitting the secure payment request page to the dedicated operating system through the information channel.

The step of completing the payment operation in the secure payment request page of the dedicated operating system comprises steps of:

loading the received secure payment request page in the dedicated operating system, after switching to the dedicated operating system; and
performing the payment operation in the secure payment request page.

The method further comprises steps of:

transmitting a payment-completed message to the general operating system, after detecting that the payment operation is completed; and
switching from the dedicated operating system to the general operating system.

The method further comprises a step of:

initiating a network filtering and/or process monitoring in the dedicated operating system.

The step of initiating the network filtering comprises steps of:

configuring a firewall in the dedicated operating system, and forbidding a connection to the dedicated operating system without a request, and/or forbidding an external program to scan a port, and/or forbidding a remote illegal access, and/or forbidding close of the firewall by configuring the firewall; or
deleting an operation entry in the dedicated operating system which is independent of the secure payment; or
adding a Uniform Resource Locator (URL) list, setting the dedicated operating system to be only capable of accessing a website in the list.

The process monitoring comprises:

maintaining a preset process white-list, customizing a dedicated file filtering driver and a process filtering driver for executing only a process in the white-list.

A client system for implementing an online secure payment comprises a general operating system, a dedicated operating system and a system management module for switching and communicating between the general operating system and the dedicated operating system, wherein

the general operating system comprises:
a secure payment request page generation unit for generating a secure payment request page for goods in the general operating system; and
a secure payment request page transmission unit for transmitting the generated secure payment request page to the dedicated operating system;
the system management module comprises:
an operating system switching unit for switching from the general operating system to the dedicated operating system, after the secure payment request page is received by the dedicated operating system; and
the dedicated operating system comprises:
a payment operation completion unit for completing a payment operation in the secure payment request page of the dedicated operating system.

The general operating system further comprises:

an access request triggering unit for triggering an access request for a payment gateway of the goods after the goods have been selected in the general operating system;
a payment gateway list determination unit for determining whether the payment gateway exists in a list of payment gateways pre-stored in the general operating system; and
a determination result execution unit for preventing the payment gateway from being accessed in the general operating system and generating the secure payment request page, if the payment gateway exists in the list of payment gateways; otherwise, the process being ended.

The secure payment request page generation unit comprises:

a payment request information extraction unit for extracting payment request information in an initial payment request page generated in the general operating system; and
a secure payment request page encapsulation unit for encapsulating the payment request information into the secure payment request page which is a file containing information on a Hypertext Transfer Protocol (HTTP) request for the payment gateway.

The system management module further comprises:

an information channel driving unit for driving an information channel between the general operating system and the dedicated operating system, when the secure payment request page is transmitted from the general operating system to the dedicated operating system; and
a secure payment request page transmission unit for transmitting the secure payment request page to the dedicated operating system through the information channel.

The payment operation completion unit comprises:

a secure payment request page loading unit for loading the received secure payment request page in the dedicated operating system, after switching to the dedicated operating system; and
a payment operation executing unit for executing the payment operation in the secure payment request page.

The dedicated operation system further comprises:

a payment-completed message transmission unit for transmitting a payment-completed message to the general operating system, after detecting in the dedicated operating system that the payment operation is completed; and
the operating system switching unit further used for switching from the dedicated operating system to the general operating system.

The dedicated operating system further comprises:

a security guard initiation unit for initiating a network filtering and/or process monitoring in the dedicated operating system.

As seen from the above, technical solutions provided by the present invention, after the client system is switched from the general operating system to the dedicated operating system, the payment operation is completed in the secure payment request page of the dedicated operating system by transmitting to the dedicated operating system the secure payment request page for goods which is generated in the general operating system. According to the present invention, the general operating system for general operations and the dedicated operating system for secure payment operations are distinguished; a protection for input and output payment information is implemented in an isolated trustable computing environment, so as to store privacy information of the user securely and persistently; and the security for the network payment is further enhanced by configuring the firewall and monitoring processes in the dedicated operating system. A seamless switch between the general operating system and the dedicated operating system is implemented by the system management module, thus operations of the client system user are not different from general online operations. Based on the enhanced security for the network payment, experiences of the user are improved. Furthermore, it is not necessary to make any modification on the existed network transaction system when the technical solution of the present invention is applied. With a virtual machine technique, functions of the dedicated operating system may be implemented, the cost may be reduced and the technical solution of the present invention is facilitated to be deployed and spread.

### BRIEF DESCRIPTION OF THE DRAWINGS

FIG. 1 is an exemplary payment flowchart in a network shopping in a prior art;

FIG. 2 is an illustrative structure diagram of a system in which a method of the present invention is applied;

FIG. 3 is a flowchart of a method according to a first embodiment of the present invention;

FIG. 4 is a flowchart of a method according to a second embodiment of the present invention;

FIG. 5 is a flowchart of a method according to a third embodiment of the present invention;

FIG. 6 is a block diagram of a client system according to the first embodiment of the present invention;

FIG. 7 is a block diagram of a client system according to the second embodiment of the present invention; and

FIG. 8 is a block diagram of a client system according to the third embodiment of the present invention.

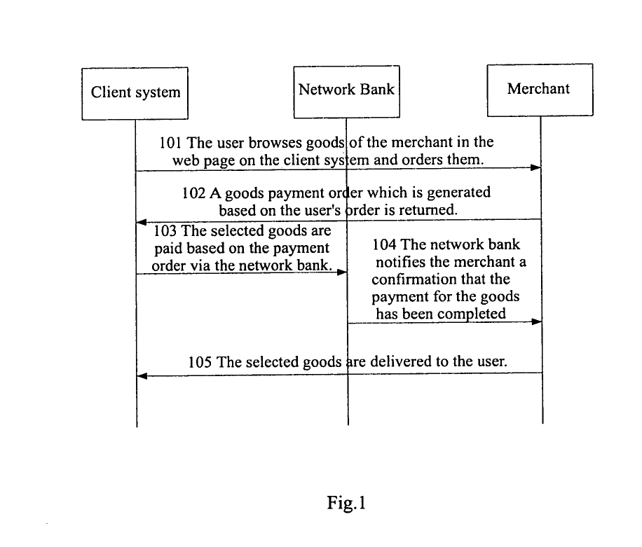

### DETAILED DESCRIPTION OF PREFERRED EMBODIMENTS

A principal idea of the present invention is to provide a method for implementing an online secure payment. In the method, a secure payment request page for goods which is generated in a general operating system is transmitted to a dedicated operating system; after the client system is switched from the general operating system to the dedicated operating system, a payment operation is completed in the secure payment request page of the dedicated operating system.

Hereinafter, the present invention will be further described in detail by referring to the drawings and the embodiments in order to make the objects, technical scheme and advantages of the present invention more apparent.

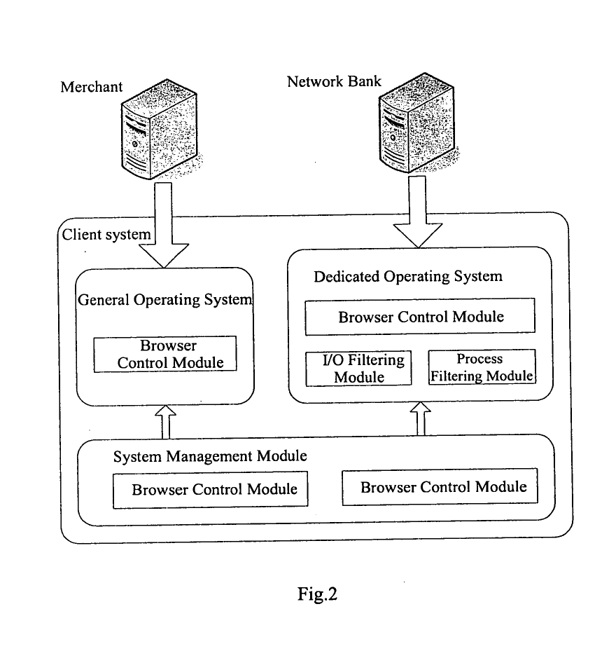

A method for processing network transaction information according to an embodiment of the present invention is based on a virtual machine technique. FIG. 2 illustrates a schematic diagram of a system structure for which the method of the embodiment of the present invention is applied. As shown in FIG. 2, three entities are still included in the system, i.e. a client system, a network bank and a merchant. The method of the embodiment of the present invention provides two separated computing environments, i.e. a common computing environment based on a general operating system and a trustable computing environment based on a dedicated operating system, for a user using the client system.

The general operating system may satisfy a common computing requirement for the client system, and perform a part of network shopping and network transactions which have a relative low security requirement. A browser control module running in the general operating system is comprised in the common computing environment, which browser control module implements a seamless secure payment by monitoring URL. Particularly, the browser control module maintains a URL list containing payment gateways of various banks. When it is detected that the user is attempting to access a payment gateway of some bank in the current general operating system, the browser control module initiates a secure payment process, transmits a secure payment requirement to the dedicated operating system and switches to the dedicated operating system.

Based on the virtual machine technique, the dedicated operating system is separated from the general operating system completely, and is dedicated to be used for the secure payment in the network transaction. A browser monitoring module is comprised in the trustable environment. The browser monitoring module is used for enabling the current network transaction to run in the dedicated operating system and displaying a payment request page of the network bank on the client system, after it receives the secure payment request from the general operating system. Simultaneously, the browser monitoring module further avoids the user to access a bank payment gateway outside the URL list from the dedicated operating system, and when the secure payment process is completed, the client system is switched from the current dedicated operating system to the general operating system. An Input/Output (I/O) filtering module is further comprised in the trustable computing environment, which I/O filtering module is used for monitoring the network and a Universal Serial Bus (USB) interface, so as to prevent the dedicated operating system from being accessed illegally except for the secure payment. A process filtering module is further comprised in the trustable computing environment, which process filtering module is used for monitoring a process schedule in the dedicated operating system, in order to prevent the initiation of an unauthorized process.

In order to switch between the general operating system and the dedicated operating system, a system management module is further comprised in the client system, which system management module is a monitoring and scheduling computing environment based on the virtual machine technique. The system management module comprises a switch control module for switching from the general operating system to the dedicated operating system during the secure payment, and switching from the dedicated operating system to the general operating system after the secure payment is executed. The system management module further comprises an intercommunication module for implementing an intercommunication such as a switch request transmission between the dedicated operating system and the general operating system.

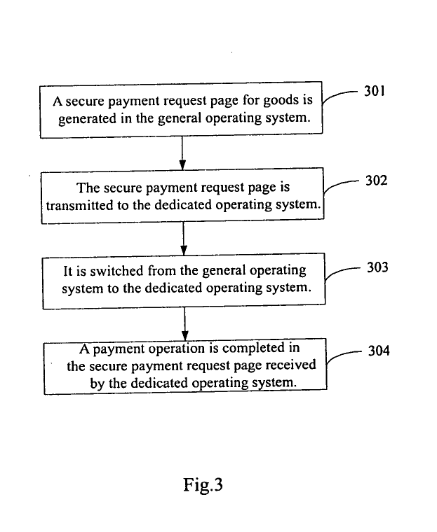

FIG. 3 is a flowchart of a first embodiment of the method according to the present invention.

As shown in FIG. 3, in step 301, a secure payment request page for goods is generated in the general operating system.

In particular, payment request information in an initial payment request page generated in the general operating system is extracted; and the payment request information is encapsulated into the secure payment request page which is a file containing information on request for HTTP of the payment gateway, such as a static Hypertext Markup Language (HTML) file.

In step 302, the secure payment request page is transmitted to the dedicated operating system.

In particular, an information channel between the general operating system and the dedicated operating system is driven, and the secure payment request page is transmitted to the dedicated operating system through the information channel.

In step 303, the client system is switched from the general operating system to the dedicated operating system.

In step 304, a payment operation is completed in the secure payment request page received by the dedicated operating system.

In particular, the received secure payment request page is loaded in the dedicated operating system after the client system is switched to the dedicated operating system.

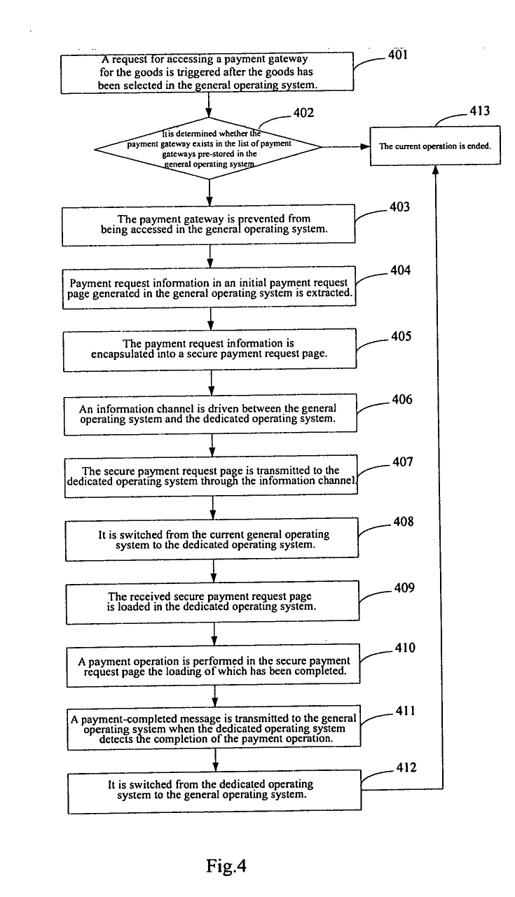

FIG. 4 illustrates a second embodiment of the method according to the present invention. As shown in FIG. 4, a detailed flowchart for implementing an online secure payment by the client system is shown in the embodiment, which further comprises an operation before the secure payment request page is generated by the client system in the general operating system, and a process of switching back to the general operating system after the client system has completed the secure payment operation in the dedicated operating system.

In step 401, a request for accessing a payment gateway for the goods is triggered after the goods has been selected in the general operating system.

The user browses goods shown by the merchant in the general operating system. When the goods he needed are selected, a subsequent network payment process may be entered. All of the network payment flows are needed to be implemented by accessing the payment gateway of the network bank. In the present invention, a fixed list of payment gateways may be pre-maintained in the general operating system. A payment gateway in the list is a gateway supporting the network payment. Generally, a browser plug-in may be set in the general operating system for maintaining the list of payment gateways.

In step 402, it is determined whether the payment gateway exists in the list of payment gateways pre-stored in the general operating system. If so, the process goes to step 403; otherwise, step 413 is executed.

When the request for accessing the payment gateway is detected in the general operating system, it is firstly determined whether the payment gateway exists in the maintained list of payment gateways.

In step 403, the payment gateway is prevented from being accessed in the general operating system.

When the payment gateway which is tried to be accessed exists in the maintained list of payment gateways, the payment gateway is forbidden to be accessed in the current general operating system.

In step 404, payment request information in an initial payment request page generated in the general operating system is extracted.

When the user selects some goods on the client system, the initial payment request page is generated at the website of the merchant who owns the goods. Associated payment request information for the goods is contained in the initial payment request page. It is required that the payment request information in the initial payment request page may be extracted for the subsequent use, since it is forbidden that the payment gateway of the bank is accessed in the current general operating system and the payment operation is completed simultaneously.

In step 405, the payment request information is encapsulated into a secure payment request page.

The payment request information extracted in the initial payment request page in step 404 may be encapsulated into the secure payment request page which is a static HTML file. Another operating system which obtains the file may load the file and transmit related payment request data by adding loading information to a BODY tag of the file.

In step 406, an information channel is driven between the general operating system and the dedicated operating system.

In the present invention, drivers for the information channel are installed respectively in the general operating system and the dedicated operating system. Communications between the general operating system and the dedicated operating system may be implemented in both the general operating system and the dedicated operating system by accessing the information channel by means of the installed drivers.

In step 407, the secure payment request page is transmitted to the dedicated operating system through the information channel.

The secure payment request page encapsulated in the general operating system is transmitted to the dedicated operating system through the information channel between the general operating system and the dedicated operating system.

In step 408, the client system is switched from the current general operating system to the dedicated operating system.

When the transmission of the secure payment request page has been completed, the secure payment operation is needed to be performed in the dedicated operating system receiving the secure payment request page. Thus, the client system is switched from the current general operating system to the dedicated operating system.

In step 409, the received secure payment request page is loaded in the dedicated operating system.

After the dedicated operating system confirms that receiving the secure payment request page has been completed and the client system has been switched to the dedicated operating system currently, the secure payment request page may be loaded in the dedicated operating system according to the loading information in the BODY tag of the secure payment request page, and the loaded secure payment request page is displayed on the current browser window for operation of the user.

In step 410, a payment operation is performed in the secure payment request page which has been completed the loading process.

The user completes the payment operation in the secure payment request page of the current dedicated operating system. The secure payment request page displayed on the window of the dedicated operating system is in accordance with the existed payment request page displayed on the window of the general operating system. Thus, the user may pay conveniently without any other operations.

Storage spaces of the general operating system and the dedicated operating system based on the virtual machine technique correspond to different parts of a hard disk, i.e. each of the operating systems may only access the corresponding part in the hard disk which is allocated to this operating system and may not access parts of the hard disk which correspond to other operating systems. Thus, privacy information required for the payment input by the user in the dedicated operating system may be stored in the part of the hard disk corresponding to the dedicated operating system, so as to guarantee the security of the privacy information.

In step 411, a payment-completed message is transmitted to the general operating system when the dedicated operating system detects the completion of the payment operation.

The user closes the current page when he finishes corresponding payment operation in the secure payment request page displayed on the window of the dedicated operating system. The dedicated operating system confirms the completion of the payment when it detects the close operation, and the payment-completed message is transmitted to the general operating system through the information channel.

In step 412, the client system is switched from the dedicated operating system to the general operating system.

After the payment-completed message is received in the general operating system, the general operating system confirms that the dedicated operating system has finished the access for the payment gateway of the network bank and completed the secure payment operation, then the client system is switched from the current dedicated operating system to the general operating system. The window for the initial shopping website may be activated in the general operating system, so that the user may continue other operations other than the secure payment operation in the general operating system.

In step 413, the current operation is ended.

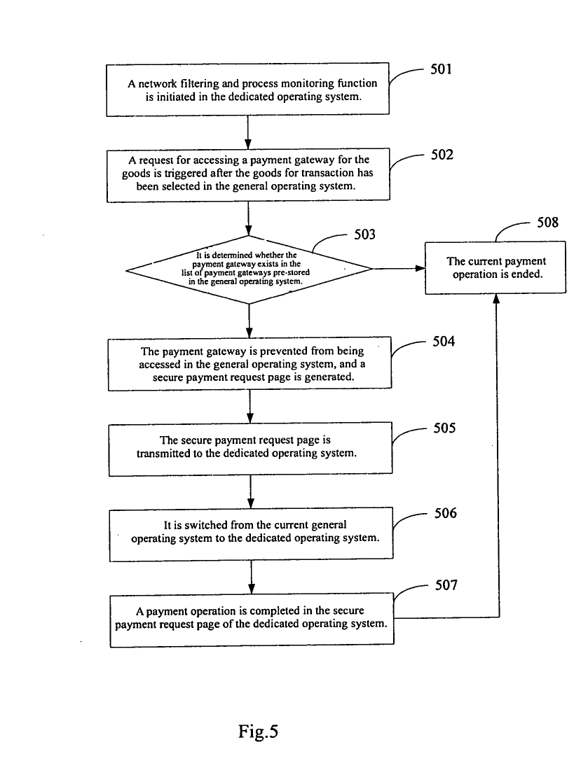

FIG. 5 illustrates a third embodiment of the method according to the present invention. In this embodiment, a process for setting a security guard function in the dedicated operating system based on operations on a network payment respectively in the general operating system and the dedicated operating system is further illustrated

In step 501, a network filtering and process monitoring function is initiated in the dedicated operating system.

In the present invention, two independent computing environments are provided for the client system user, i.e. a common computing environment based on the general operating system and a trustable computing environment based on the dedicated operating system, for a user using the client system. The user may execute a general operation in the common computing environment, while execute an operation with high security and high privacy such as the network payment in the trustable computing environment. In order to further improve security of the trustable computing environment based on the dedicated operating system, functions such as the network filtering and the process monitoring may be initiated in the dedicated operating system.

In order to perform the network filtering on the dedicated operating system, a firewall in the dedicated operating system may be used in the dedicated operating system. Or a third-party firewall may be configured. According to actual requirements, the firewall may be set to filter packets, i.e. to forbid an unauthorized connection request from an external network, and may restrict traffic and a connection number for each of IP addresses. The firewall may be set not to respond a Ping command, i.e. to forbid an external program to perform a port scanning on the client system. The firewall may be set to forbid a remote illegal access and an attack from the external network, and may further be set to forbid the user who uses the client system to close the firewall etc. In order to perform the process monitoring on the dedicated operating system, a process white-list may be pre-set. Programs in the process white-list are authorized programs, i.e. programs which may run in the dedicated operating system. The process white-list may be obtained by software installation or upgrading, and can not be modified by the user. Only processes in the white-list may be performed by customizing a dedicated file filtering driver and a progress filtering driver. Generally, programs in the process white-list are software or IE plug-ins such as an IE client system plug-in of some bank required for the secure payment. When corresponding program such as a media player which is not relevant to the secure payment occurs, the program may be forbidden since it is not included in the process white-list.

In step 502, a request for accessing a payment gateway for the goods is triggered after the goods has been selected in the general operating system.

In step 503, it is determined whether the payment gateway exists in the list of payment gateways pre-stored in the general operating system. If so, the process goes to step 504; otherwise, step 508 is executed.

In step 504, the payment gateway is prevented from being accessed in the general operating system, and a secure payment request page is generated.

In step 505, the secure payment request page is transmitted to the dedicated operating system.

In step 506, the client system is switched from the general operating system to the dedicated operating system.

In step 507, a payment operation is completed in the secure payment request page of the dedicated operating system.

In step 508, the current payment operation is ended.

A client system for implementing an online secure payment is further provided in the present invention, which is corresponding to the method for implementing an online secure payment. The client system implements a general network operation by the general operating system, implements a secure payment operation by the dedicated operating system, and implements a switch and a communication between the general operating system and the dedicated operating system by a system management module.

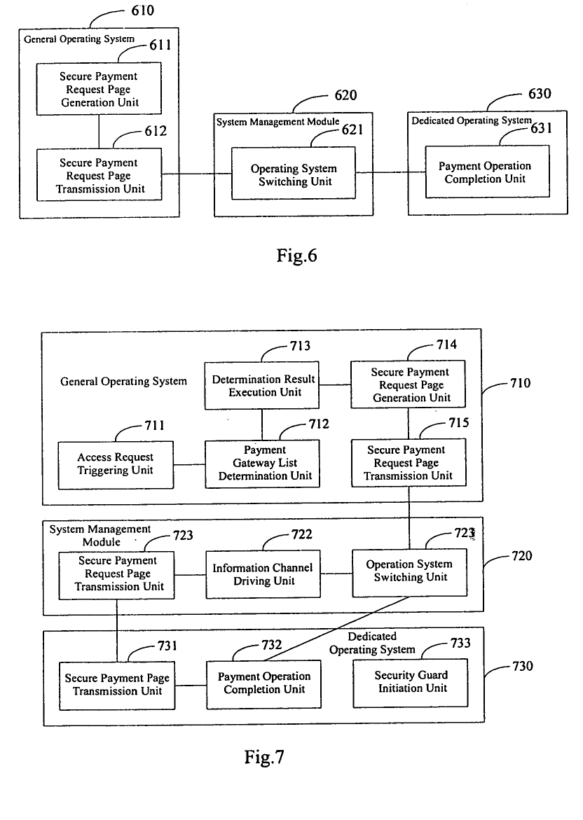

FIG. 6 shows a first embodiment of the client system for the online secure payment according to the present invention.

The client system comprises a general operating system 610, a system management module 620 and a dedicated operating system 630.

The general operating system 610 comprises: a payment request page generation unit 611 for generating a secure payment request page for goods in the general operating system; a payment request page transmission unit 612 for transmitting the generated secure payment request page to the dedicated operating system.

The system management module 620 comprises: an operating system switching unit 621 for switching from the general operating system 610 to the dedicated operating system 630, after the secure payment request page is received by the dedicated operating system 630.

The dedicated operating system 630 comprises:

a payment operation completion unit 631 for completing a payment operation in the secure payment request page of the dedicated operating system 630.

FIG. 7 shows a second embodiment of the client system for the online secure payment according to the present invention.

The client system comprises a general operating system 710, a system management module 720 and a dedicated operating system 730.

The general operating system 710 comprises: an access request triggering unit 711 for triggering an access request for a payment gateway of the goods after the goods have been selected in the general operating system; a payment gateway list determination unit 712 for determining whether the payment gateway exists in a list of payment gateways pre-stored in the general operating system; a determination result execution unit 713 for preventing the payment gateway from being accessed in the general operating system and generating the secure payment request page, when the payment gateway exists in the list of payment gateways; otherwise, the process being ended; a secure payment request page generation unit 714 for generating a secure payment request page for goods in the general operating system; and a secure payment request page transmission unit 715 for transmitting the generated secure payment request page to the dedicated operating system.

The system management module 720 comprises: an operation system switching unit 721 for switching from the general operating system 710 to the dedicated operating system 730, after the secure payment request page is received by the dedicated operating system 730; an information channel driving unit 722 for driving an information channel between the general operating system and the dedicated operating system, when the secure payment request page is transmitted to the dedicated operating system by the general operating system; and a secure payment request page transmission unit 723 for transmitting the secure payment request page to the dedicated operating system through the information channel.

The dedicated operating system 730 comprises a payment operation completion unit 731 for completing a payment operation in the secure payment request page of the dedicated operating system 730; a payment-completed message transmission unit 732 for transmitting a payment-completed message to the general operating system 710 after the completion of the payment operation is detected in the dedicated operating system; a operating system switching unit 721 in corresponding system management module 720 which is further used for switching from the dedicated operating system 730 to the general operating system 710; a security guard initiation unit 733 for initiating the network filtering and/or process monitoring in the dedicated operating system 730.

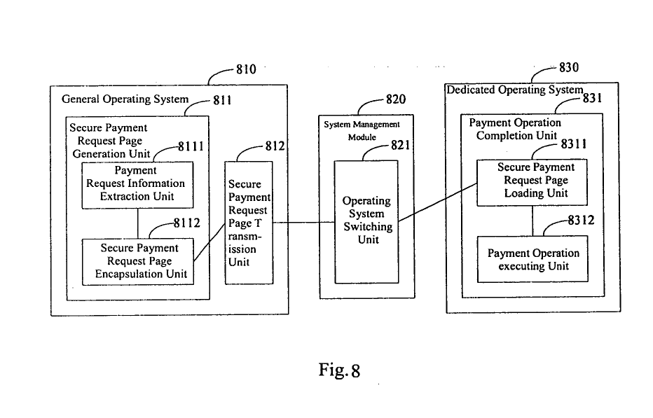

FIG. 8 shows a third embodiment of the client system for the online secure payment according to the present invention.

The client system comprises a general operating system 810, a system management module 820 and a dedicated operating system 830. The general operating system 810 comprises: a secure payment request page generation unit 811 for generating a secure payment request page for goods in the general operating system; a secure payment request page transmission unit 812 for transmitting the generated secure payment request page to the dedicated operating system. The system management module 820 comprises: an operating system switching unit 821 for switching from the general operating system 810 to the dedicated operating system 830, after the secure payment request page is received by the dedicated operating system 830. The dedicated operating system 830 comprises: a payment operation completion unit 831 for completing a payment operation in the secure payment request page of the dedicated operating system 830.

The secure payment request page generation unit 811 comprises a payment request information extraction unit 8111 for extracting payment request information in an initial payment request page generated in the general operating system; and a secure payment request page encapsulation unit 8112 for encapsulating the payment request information into the secure payment request page which is a file containing information on request for HTTP of the payment gateway.

The payment operation completion unit 831 comprises: a secure payment request page loading unit 8311 for loading the received secure payment request page in the dedicated operating system, after switching to the dedicated operating system; and a payment operation executing unit 8312 for executing the payment operation in the secure payment request page.

As seen from the above embodiments of the present invention, the general operating system for general operations is distinguished from the dedicated operating system for secure payment operations; a protection for input and output payment information is implemented in an isolated trustable computing environment, so as to store privacy information of the user securely and persistently; and the security for the network payment is further enhanced by configuring the firewall and monitoring processes in the dedicated operating system. A seamless switch between the general operating system and the dedicated operating system is implemented by the system management module, thus there is no difference between operations of the client system user and general online operations. Based on the enhanced security for the network payment, experiences of the user are improved. Furthermore, it is not necessary to make any modification on the existed network transaction system when the technical solution of the present invention is applied. With a virtual machine technique, functions of the dedicated operating system may be implemented, the cost may be reduced and the technical solution of the present invention is facilitated to be deployed and spread.

The above is only the preferred embodiments of the present invention and the present invention is not limited to the above embodiments. Therefore, any modifications, substitutions and improvements to the present invention are possible without departing from the spirit and scope of the present invention.

What is claimed is:

1. A method for implementing an online secure payment, comprises steps of:
transmitting to a dedicated operating system a secure payment request page for goods which is generated in a general operating system;
completing a payment operation in the secure payment request page of the dedicated operating system, after switching from the general operating system to the dedicated operating system.

2. The method according to claim 1, further comprising steps of:
triggering an access request for a payment gateway of the goods after the goods have been selected in the general operating system; and
determining whether the payment gateway exists in a list of payment gateways pre-stored in the general operating system; if so, preventing the payment gateway from being accessed in the general operating system, and generating the secure payment request page.

3. The method according to claim 1, wherein the step of generating the secure payment request page in the general operating system comprises steps of:
extracting payment request information in an initial payment request page generated in the general operating system; and
encapsulating the payment request information into the secure payment request page which is a file containing information on a Hypertext Transfer Protocol (HTTP) request for the payment gateway.

4. The method according to claim 1, wherein the step of transmitting to the dedicated operating system the secure payment request page comprises steps of:
driving an information channel between the general operating system and the dedicated operating system; and
transmitting the secure payment request page to the dedicated operating system through the information channel.

5. The method according to claim 1, wherein the step of completing the payment operation in the secure payment request page of the dedicated operating system comprises steps of:
loading the received secure payment request page in the dedicated operating system, after switching to the dedicated operating system; and
performing the payment operation in the secure payment request page.

6. The method according to claim 1, further comprising steps of:
transmitting a payment-completed message to the general operating system, after detecting that the payment operation is completed; and
switching from the dedicated operating system to the general operating system.

7. The method according to claim 1, further comprising a step of:
initiating a network filtering and/or process monitoring in the dedicated operating system.

8. The method according to claim 7, wherein the step of initiating the network filtering comprises steps of:
configuring a firewall in the dedicated operating system, and forbidding a connection to the dedicated operating system without a request, and/or forbidding an external program to scan a port, and/or forbidding a remote illegal access, and/or forbidding close of the firewall by configuring the firewall; or
deleting an operation entry in the dedicated operating system which is independent of the secure payment; or
adding a Uniform Resource Locator (URL) list, and setting the dedicated operating system to be only capable of accessing a website in the list.

9. The method according to claim 7, wherein the process monitoring comprises:
maintaining a preset process white-list, customizing a dedicated file filtering driver and a process filtering driver for executing only a process in the white-list.

10. A client system for implementing an online secure payment, comprising a general operating system, a dedicated operating system and a system management module for switching and communicating between the general operating system and the dedicated operating system, wherein
the general operating system comprises:
a secure payment request page generation unit for generating a secure payment request page for goods in the general operating system, and
a secure payment request page transmission unit for transmitting the generated secure payment request page to the dedicated operating system;
is the system management module comprises:
an operating system switching unit for switching from the general operating system to the dedicated operating system, after the secure payment request page is received by the dedicated operating system; and
the dedicated operating system comprises:
a payment operation completion unit for completing a payment operation in the secure payment request page of the dedicated operating system.

11. The client system according to claim 10, wherein the general operating system further comprises:
an access request triggering unit for triggering an access request for a payment gateway of the goods after the goods have been selected in the general operating system;
a payment gateway list determination unit for determining whether the payment gateway exists in a list of payment gateways pre-stored in the general operating system; and
a determination result execution unit for preventing the payment gateway from being accessed in the general operating system and generating the secure payment request page, if the payment gateway exists in the list of payment gateways.

12. The client system according to claim 10, wherein the secure payment request page generation unit comprises:
a payment request information extraction unit for extracting payment request information in an initial payment request page generated in the general operating system; and
a secure payment request page encapsulation unit for encapsulating the payment request information into the secure payment request page which is a file containing information on a Hypertext Transfer Protocol (HTTP) request for the payment gateway.

13. The client system according to claim 10, wherein the system management module further comprises:
an information channel driving unit for driving an information channel between the general operating system and the dedicated operating system, when the secure payment request page is transmitted from the general operating system to the dedicated operating system; and
a secure payment request page transmission unit for transmitting the secure payment request page to the dedicated operating system through the information channel.

14. The client system according to claim 10, wherein the payment operation completion unit comprises:
a secure payment request page loading unit for loading the received secure payment request page in the dedicated operating system, after switching to the dedicated operating system; and
a payment operation executing unit for executing the payment operation in the secure payment request page.

15. The client system according to claim 10, wherein the dedicated operation system further comprises:
a payment-completed message transmission unit for transmitting a payment-completed message to the general operating system, after detecting in the dedicated operating system that the payment operation is completed; and
wherein the operating system switching unit is further used for switching from the dedicated operating system to the general operating system.

16. The client system according to claim 10, wherein the dedicated operation system further comprises:
a security guard initiation unit for initiating a network filtering and/or process monitoring in the dedicated operating system.
